(19) United States
(12) Patent Application Publication
(10) Pub. No.: US 2006/0006173 A1
(43) Pub. Date: Jan. 12, 2006

(54) Bar-code reading cooking apparatus and method

(75) Inventors: Kwang Keun Kim, Seoul-City (KR); Seok Weon Hong, Yongin-City (KR); Yu Jeub Ha, Suwon-Si (KR); Hyun Suk Kim, Yongin-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/121,927

(22) Filed: May 5, 2005

(30) Foreign Application Priority Data
Jul. 8, 2004 (KR) 2004-53090

(51) Int. Cl. H05B 6/50

(52) U.S. Cl. 219/714

(57) ABSTRACT

Disclosed herein is a cooking apparatus that is capable of performing an optimal cooking process irrespective of the state of food. A cooking method of the same is also disclosed. The cooking method includes reading and interpreting a bar-code storing cooking information, confirming the state of food to be cooked on the basis of the cooking information, and cooking the food using the cooking information and the state of the food.

### CROSS-REFERENCE TO RELATED APPLICATIONS

This application claims the benefit of Korean Patent Application No. 2004-53090, filed on Jul. 8, 2004 in the Korean Intellectual Property Office, the disclosure of which is incorporated herein by reference.

### BACKGROUND OF THE INVENTION

1. Field of the Invention

The present invention relates to a cooking apparatus and method, and more particularly, to a cooking apparatus and method for reading a bar-code attached to a food package to optimally cook the food therein.

2. Description of the Related Art

Generally, cooking apparatuses are devices that cook food using various heating sources. On the basis of heating sources, the cooking apparatuses are classified into several types of cooking apparatuses. For example, a microwave oven is a cooking apparatus that cooks foods using microwaves. In the conventional microwave oven, a user directly inputs cooking time, cooking mode, and kinds of food to be cooked through the use of a key input unit formed at the front panel of the microwave oven. In other words, it is necessary that the user manually input cooking information. Consequently, appropriate cooking conditions are not easily and conveniently set.

In order to solve the above-mentioned problem, a microwave oven with a bar-code reader has been developed that is capable of cooking foods on the basis of cooking information read by means of a bar-code reader. Such a microwave oven is disclosed in Korean Unexamined Patent Publication No. 2001-0010530 and Korean Unexamined Patent Publication No. 1999-0074607.

The conventional microwave ovens with bar-code readers include a cooking chamber disposed in an oven body, a built-in bar-code reader disposed on the front panel of the oven body (or a charge coupled display-type or pen-type bar-code reader that is connected to the oven body via a cable), a display unit that displays the operation of the microwave oven, an input unit comprising a plurality of input buttons, and a magnetron that generates microwaves to be supplied to the cooking chamber.

To perform a cooking process in the microwave oven with a bar-code reader described above, a user brings a bar-code attached to a food package to the bar-code reader to read the bar-code, and the microwave oven performs the cooking process according to the cooking information stored in the bar-code.

However, when food that is designed to be chilled is frozen, the food is cooked on the basis of the cooking information suitable to the chilled state in the microwave oven with a bar-code reader as described above. As a result, wrongly frozen food is not cooked properly.

Specifically, the cooking information stored in the bar-code printed on the food package are set such that the food can only be optimally cooked when it is chilled. Consequently, when the food wrongly frozen is cooked according to the cooking information stored in the bar-code without leaving the food to thaw before cooking, the food is not optimally cooked.

### SUMMARY OF THE INVENTION

It is an aspect of the invention to provide a cooking apparatus that is capable of performing an optimal cooking process irrespective of the state of food.

It is a further aspect of the invention to provide a cooking apparatus that is capable of performing an optimal cooking process irrespective of the state of the food designed to be chilled.

It is another aspect of the invention to provide a cooking method of the same.

In accordance with one aspect, the present invention provides a cooking method for use with a bar-code reading cooking apparatus that includes: reading and interpreting a bar-code storing cooking information; confirming the state of food to be cooked on the basis of the cooking information; and automatically changing the state of the food to be cooked using the cooking information when the state of the food to be cooked makes it inappropriate to cook the food on the basis of cooking conditions of the cooking information, and performing a cooking process on the basis of the cooking conditions.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a front view of a microwave oven according to an embodiment of the present invention;

FIG. 2 is a block diagram of the microwave oven shown in FIG. 1;

FIG. 3 is a view showing cooking information stored in a bar-code read by the bar-code reader of the microwave oven; and

FIG. 4 is a flowchart showing the operational algorithm of the microwave oven shown in FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

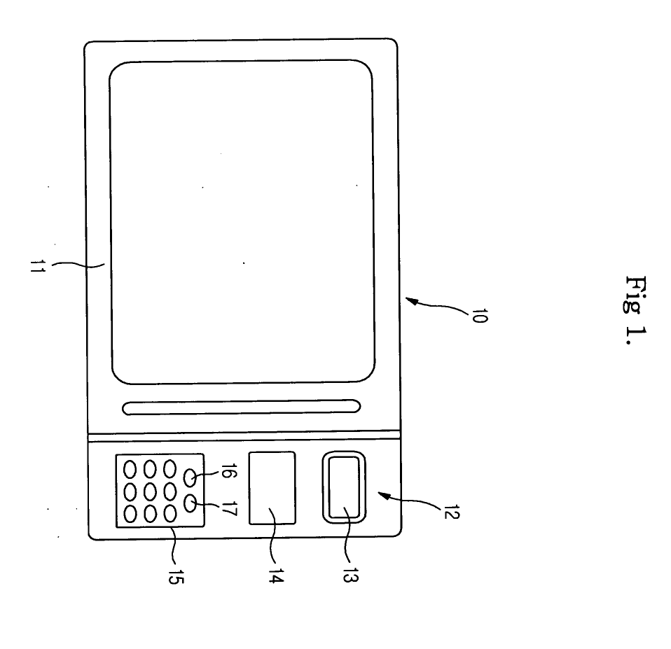

Referring to FIG. 1, a microwave oven according to an embodiment of the present invention includes a door 11 disposed in front of an oven body 10 and a front panel 12 disposed at the right side of the door 12.

The front panel 12 includes a display unit 13 disposed at the upper part thereof for displaying the operational status of the microwave oven, a built-in bar-code reader 14 disposed below the display unit 13 for reading a bar-code, and an input unit 15 disposed below the bar-code reader 14. The input unit 15 has a plurality of input buttons. For example, the input unit 15 may have a chilled-state button 16 and a frozen-state button 17.

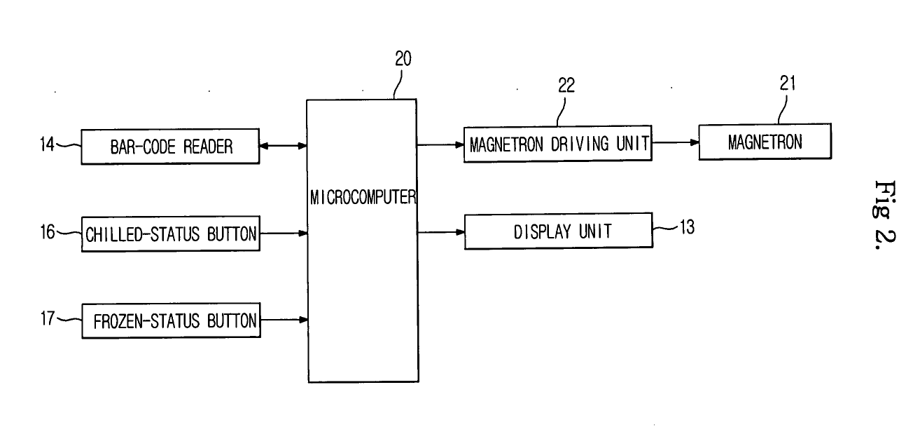

The chilled-state button 16 and the frozen-state button 17 are used to input the state of the food to be cooked. When the food to be cooked is designed to be chilled, a user presses the chilled-state button 16. When the food to be cooked is designed to be frozen, the user presses the frozen-state button 17. When the chilled-state button 16 or the frozen-state button 17 is pressed, the state of the food to be cooked is transmitted to a microcomputer 20 (See FIG. 2), which will be described below.

Referring to FIG. 2, the microwave oven shown in FIG. 1 further includes: a magnetron-driving unit 22 to drive a magnetron 21 that generates microwaves to be supplied to a cooking chamber; and a microcomputer 20 to interpret a bar-code read by means of the bar-code reader 14 and control the respective components of the microwave oven.

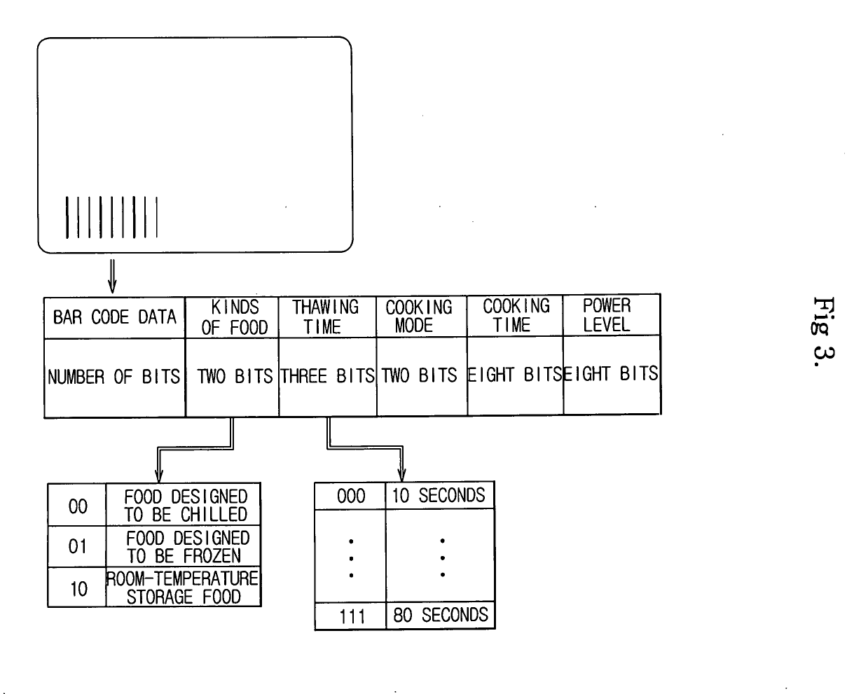

As is shown in FIG. 3, the bar-code read by the bar-code reader 14 of FIG. 2 stores cooking information including kinds of food, thawing time, and various cooking information such as cooking conditions. Also, the microcomputer 20 stores interpreting rules as indicated in the table shown in FIG. 3. Specifically, the interpreting rules stored in the microcomputer 20 prescribe what cooking information each line of the bar code stores, and what the detailed contents of the cooking information corresponding to the value of the read bar-code are.

On the basis of “kinds of food,” one component of the cooking information, food is classified into food designed to be chilled, food designed to be frozen, and food designed to be stored at room temperature. Different bar-code values are given according to the classifications listed above.

For example, two bits are assigned to the bar-code for storing the kinds of food. When the read bar-code is “00,” the microcomputer 20 interprets that the food to be cooked is food designed to be chilled. When the read bar code is “01,” the microcomputer 20 interprets that the food to be cooked is food designed to be frozen. When the read bar code is “11,” the microcomputer 20 interprets that the food to be cooked is room-temperature storage food.

The thawing time is set to thaw wrongly frozen food, which should have been chilled, or frozen food before it is cooked. For example, three bits are assigned to the bar code for storing the thawing time. When the read bar code is “000,” the microcomputer 20 interprets that the thawing time is 10 seconds. When the read bar code is “111,” the microcomputer 20 interprets that the thawing time is 80 seconds. The thawing time may vary on the basis of the kind or the amount of food to be cooked.

The cooking conditions include cooking mode, cooking time, and power level. On the basis of the cooking mode, the cooking process is performed using microwaves or an electric heater mounted in the microwave oven. The power level is used to set the output of the magnetron.

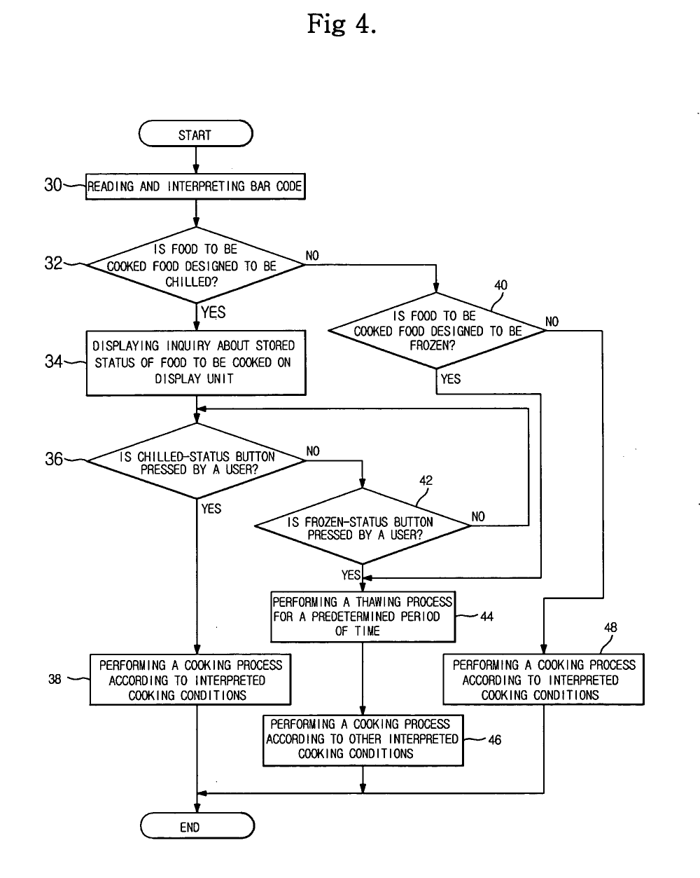

FIG. 4 is a flowchart showing the cooking process performed in the microwave oven shown in FIG. 2. When a user brings a bar-code printed on a food package to the bar-code reader 14, the bar-code reader reads the bar-code. The bar-code read by the bar-code reader 14 is transmitted to the microcomputer 20, which interprets the cooking information stored in the read bar-code using the previously stored interpreting rules (S30).

Upon completion of the interpretation of the read bar-code, the microcomputer 20 determines whether the food to be cooked is food designed to be chilled or not (S32). When the read bar-code is “00” for the kinds of food according to the interpreting rules as shown in FIG. 3, the microcomputer 20 determines that the food to be cooked is food designed to be chilled.

When the food to be cooked is food designed to be chilled, an inquiry about the stored state of the food is displayed on the display unit 13 so that a user can input the state of the food designed to be chilled (S34). When the food is chilled, the user presses the chilled-state button 16. When the food is frozen, the user presses the frozen-state button 17.

Subsequently, the microcomputer 20 determines whether the chilled-state button 16 is pressed or not by the user (S36). If it is determined that the chilled-state button 16 is pressed, the microcomputer 20 interprets that the food is chilled, and thus a cooking process is preformed according to the interpreted cooking conditions (S38). If it is determined that the chilled-state button 16 is not pressed, on the other hand, the microcomputer 20 determines whether the frozen-state button 17 is pressed or not by the user (S42).

If it is determined that the frozen-state button 17 is not pressed, the procedure is returned to operation 36. If it is determined that the frozen-state button 17 is pressed, on the other hand, the microcomputer 20 drives the magnetron 21 to perform a thawing process for a period of time interpreted at the bar code, since the food, designed to be chilled, is frozen (S44). When the thawing process is completed, the cooking process is carried out according to the cooking conditions (cooking mode, cooking time, power level) (S46).

As can be easily understood from the above description, food is not directly cooked on the basis of the interpreted cooking conditions when the food, designed to be chilled, is frozen. The wrongly frozen food is thawed for a predetermined period of time, i.e., until the food reaches the normally chilled state, and is then cooked on the basis of the cooking conditions. Consequently, the food is optimally cooked.

When it is determined at operation S32 that the food to be cooked is not food designed to be chilled, the bar code is read to determine whether the food to be cooked is food designed to be frozen (S40). If it is determined that the food to be cooked is food designed to be frozen, the microcomputer 20 drives the magnetron 21 to perform a thawing process for a predetermined period of time interpreted at the bar code, and performs a cooking process according to the interpreted cooking conditions (S44 and S46). If it is determined that the food to be cooked is not food designed to be frozen, on the other hand, the microcomputer 20 confirms that the food to be cooked is room-temperature storage food, and performs a cooking process according to the interpreted cooking conditions without performing a thawing process (S48).

As apparent from the above description, the present invention provides a cooking apparatus and method that is capable of automatically thawing wrongly frozen food before cooking when the wrongly frozen food is food that should have been in chilled storage, thereby accomplishing optimal cooking results irrespective of the state of the food to be cooked.

Also, a thawing process is automatically carried out without a control command from a user when it is confirmed that food, designed to be chilled, is frozen. Consequently, the chilled food is conveniently cooked.

Although an embodiment of the present invention has been shown and described, it would be appreciated by those skilled in the art that changes may be made in this embodiment without departing from the principles and spirit of the invention, the scope of which is defined in the claims and their equivalents.

1. A method of cooking food using a cooking apparatus having a bar-code reader, comprising:
reading and interpreting a bar code attached to a packet of food, the bar code including cooking information;
confirming the state of food to be cooked based on the cooking information; and
cooking the food based on the state of the food and cooking information.

2. The method according claim 1, further comprising:
automatically changing the state of the food to be cooked using the cooking information when the state of the food to be cooked makes it inappropriate to cook the food on the basis of cooking conditions of the cooking information, and performing a cooking process on the basis of the cooking conditions.

3. The method according to claim 1, wherein the state of the food is chilled food or frozen food.

4. The method according to claim 1, wherein the food to be cooked is designed to be chilled, and, when the food is frozen, the food is thawed for a predetermined period of time to change the state of the food under the determination that the state of food makes it inappropriate to cook the food on the basis of the cooking conditions, and the cooking process is performed according to the cooking conditions.

5. The method according to claim 1, wherein the state of the food is room-temperature food.

6. The method according to claim 1, wherein a thawing time is included in the cooking information.

7. The method according to claim 1, wherein an inquiry about the state of the food to be cooked is displayed on a display unit included in the cooking apparatus so that a user can input the state of the food, and the state of the food is confirmed on the basis of the information inputted by the user.

8. The method according to claim 1, wherein determination as to whether the food to be cooked is designed to be chilled is confirmed according to kinds of food included in the cooking information.

9. The method according to claim 1, wherein the food to be cooked is designed to be chilled, and, when the food is chilled, the process is performed according to the cooking conditions under the determination that the state of the food to be cooked makes it appropriate to cook the food on the basis of the cooking conditions.

10. A cooking apparatus comprising:
a bar-code reader to read a bar-code on a package of food, the bar-code including cooking information;
a control unit to interpret the cooking information read by the bar-code reader; and
a driving unit to perform the cooking process according to a control command from the control unit,
wherein the control unit thaws food to be cooked for a predetermined period of time according to the cooking information, when the food, designed to be chilled, is frozen, and performing a cooking process according to the cooking conditions of the cooking information.

11. The apparatus according to claim 10, further comprising:
a display unit to display an inquiry about the state of the food to be cooked.

12. The apparatus according to claim 10, wherein the input unit has a chilled-state button and a frozen state button for the user to input the state of the food to be cooked.
